(19) United States
(12) Patent Application Publication
(10) Pub. No.: US 2007/0024229 A1
(43) Pub. Date: Feb. 1, 2007

(54) Control Loop Performance using a Variable Speed Drive as the Final Control Element

(76) Inventor: Richard H. Caro, Acton, MA (US)

Correspondence Address: Richard H. Caro, 2 Beth Circle, Acton, MA, 01720-3407, US

(21) Appl. No.: 11/425,630

(22) Filed: Jun. 21, 2006

Related U.S. Application Data
(60) Provisional application No. 60/694,928, filed on Jun. 30, 2005.

(51) Int. Cl. H02P 1/24

(52) U.S. Cl. 318/727

(57) ABSTRACT

An AC electronic variable speed drive unit is used to power an AC induction motor that drives a centrifugal pump at controlled speeds for controlling the flow of a fluid process. The feedback loop controller function is implemented in the variable speed drive electronics, another network device, or may be located in a separate controller. This drive/motor/pump unit is used instead of a more conventional process control valve, with its attending actuator and positioning device, in order to improve the responsiveness, stability, and accuracy of the control loop. Coincidently, it also reduces the energy required for the process by the elimination of pressure drop across the control valve and allows a lower cost, smaller electric motor and pump to be used. Elimination of the control valve eliminates a source of fugitive emission through the valve packing, and reduces maintenance requirements that are necessary for a control valve. An AC electronic variable speed drive unit is used to power an AC induction motor that drives a fan at controlled speeds for controlling the airflow to a boiler or HVAC (heating, ventilating, and air conditioning) system. The feedback loop airflow controller function is implemented in the variable speed drive electronics, another device on the network, or may be located in a separate controller. This drive/motor/fan unit is used instead of a more conventional damper with its attending actuator and a positioning device in order to improve the responsiveness, stability, and accuracy of the control loop. Coincidently, it also reduces the energy required for the air handling system by the elimination of pressure drop across the damper, and allows a smaller fan and electric motor to be used. Elimination of the variable positioning air damper eliminates a source of noise, valuable in HVAC applications, and eliminates maintenance requirements for this mechanical device.

### CROSS-REFERENCE

This non-provisional application is a conversion of a provisional Patent Application U.S.60/694,928 with a filing date of Jun. 30, 2005 entitled “Advanced final control element for process control.”

### PROCESS CONTROL

This invention uses the same type of pump normally used for process control except that it is driven by a variable speed AC motor/drive combination, which also provides control action over the rate of fluid flow by modulation of the pump speed. The effect of a change in pump rotational speed is immediate, direct, and highly linear, as opposed to the deadtime delay resulting from the use of a control valve and its closed loop positioning device. Since there is no control valve, there is no possibility of hysteresis that results from valve stickiness, and the control loop may be tuned for optimal process performance without the potential of instability caused by that hysteresis. The relationship between flow rate through the control valve and the position of the valve stem is highly non-linear and is typically corrected with the use of a mechanical cam or software profiles designed to provide an approximation of linearization. Lack of a control valve also eliminates the pressure loss from that source, and both the pump and the motor size may be substantially reduced. The pump capacity only needs to provide for head (pressure) requirements stemming from process elevation differences and fluid flow friction losses in the piping. The reduction in pump head and electric motor size allows significant cost savings during new construction. Avoidance of the control valve will also allow significant saving by elimination of this expensive component, but these savings are partially offset by the required investment in the AC variable speed drive and in the more expensive type of electric motor suitable for use with a variable speed drive.

While recent fieldbus technology has allowed the final loop control computations to be located in process control valve positioners. location of such computations in a variable speed AC electric motor drives have never before been proposed for purposes of flow control. Use of this device for both motor speed control and for the final control computation avoids the deadtime and hysteresis effects of the process control valve and results in more responsive process control loop performance, improved control loop stability, and higher control loop accuracy.

For process control, this invention consists of the following elements;
Substitution of a smaller process pump and a smaller variable speed AC drive/motor combination for a control valve, control valve positioner, larger process pump, and larger constant speed AC motor for the purpose of improved process control loop pertormance, and
The location of process control loop functional algorithms, also called function blocks, in the same electronics as used for variable speed drive speed control, or optionally in a separate process controller.

### Airflow Control

This invention uses the same type of fan normally used for air handling except that it is driven by a variable speed AC motor/drive combination. There is no damper, therefore pressure loss and any positioning inaccuracies from that equipment are eliminated, and the size of both the fan and the electric motor size may substantially be reduced. The fan capacity needs only to provide for pressure losses due to friction in the airflow ducting. The reduction in fan capacity and electric motor size allows significant cost savings during installation by using a smaller electric motor and fan. Elimination of the damper and its positioning mechanism also saves investment, but these savings are partially offset by the required investment in the AC variable speed drive and in the more expensive type of electric motor suitable for use with a variable speed drive.

While recent fieldbus technology has allowed the final loop control computations to be located in process control valve positioners, location of such computations in a variable speed AC electric motor drive has never before been proposed for purposes of air handling flow control. Use of the variable speed drive for both motor speed control and for the final control computation avoids the deadtime and positioning inaccuracies of the air damper aid its positioning mechanism, and results in more responsive air handling control loop performance, improved control loop stability, and more accurate airflow control loop performance

For air handling control, this invention consists of the following elements:
Substitution of a smaller air handling fan and a smaller variable speed AC drive/motor combination for a damper, the damper positioning mechanism, larger tan, and larger constant speed AC motor, for the purpose of improved air flow control, and
The location of process control loop functional algorithms, also called function blocks, in the same electronics as used for variable speed drive speed control, or optionally in a separate controller.

### BACKGROUND OF THE INVENTION

For many years, the dominant final control element used in process control systems has been the pneumatic operated process control valve with its attached positioner. Electrical and hydraulic actuators and positioning devices have also been used in this service. While adequate control action could be achieved with these mechanical devices, control loop stability problems could usually be traced to errors in control valve position caused by “stickiness” of the sliding or rotating,valve stem position due to wear and/or chemical deposits left behind as the process fluid would leak (fugitive emissions) through the valve packing or seal. Stickiness problems appear as hysteresis in the valve mechanism causing time delays in the control actions resulting in control loop instability when the control loop is optimally tuned for best process performance.

In control of combustion and ventilation equipment, it has been common to use variable positioning air dampers operated by an electric motor-driven mechanical mechanism to modulate airflow from a fan driven by a constant speed electric motor. Linear pneumatic and hydraulic actuators are also used to open and close dampers. The air is being admitted to a boiler for combustion, or is required for a process or a building ventilation system. Air dampers are crude devices that are not capable of being positioned accurately or repeatably. An electric motor with a worm-gear drive that is most often used to operate the dampers is usually a slow response device. The damper mechanism is usually somewhat “loose” giving a non-repeatable air restriction for any one position of the actuator mechanism. This results in errors in the closed loop control of the boiler or cooling application causing unstable control at worst, or delayed response at best.

Control action with a control valve is achieved by reducing or increasing the resistance to flow by opening or closing the control valve respectively as the process fluid passes through the control valve's opening. The resulting pressure drop is the cost of this method of flow control. The control valve must be sized to pass the maximum amount of process fluid required for the process. The process pump to move the fluid must be sized to have the same maximum fluid flow capacity and the capability to develop the pressure or head required to overcome any process elevation requirements, fluid flow friction losses, and the pressure loss across the control valve. The pump is usually driven by a constant speed AC electrical motor. The energy lost due to pressure drop across the control valve is unrecoverable.

The flow rate of air is controlled by reducing or increasing the resistance to flow by closing or opening the air damper respectively as air passes through the damper. The damper must be sized to pass the maximum amount of air required for combustion or ventilation. The fan must be sized to have the air movement capacity and to overcome any ductwork frictional losses (pressure drop) and the pressure loss through the air damper. The fan is usually driven by a constant speed AC electrical motor. The energy lost due to pressure drop across the damper is unrecoverable

### DISCUSSION OF PRIOR ART

The invention of the AC variable speed drive by Reliance Electric in the late 1970's made the replacement of the pneumatic control valve a possibility. This fact was noticed by Exxon and was a major factor in their purchase of Reliance in 1981, even though this application was not mentioned in the original Reliance Patent. However, Exxon was unable to capitalize on this apparent benefit. Over the succeeding years, individual projects were implemented to substitute the AC variable speed drive/motor/pump combination for individual problem pneumatic control valves, but never implementing feedback flow control computations in the variable speed drive. The benefits of improved control loop stability, elimination of fugitive emissions, and reduction in maintenance expense were not observed or reported from these individual projects, however, they all noted the energy savings achieved by elimination of the pressure drop across the control valve.

Likewise, variable speed drives have been used on fan motors on several individual projects, usually to save energy by elimination of the dampers. These projects reported the energy savings, but did not note any improvement in the control of airflow, which for boiler control is critical, but for many HVAC applications was not relevant. They also did not report savings in maintenance of the air handling system, or reduction in noise from the elimination of the damper and use of a smaller fan and AC motor. None of these projects attempted to integrate airflow control computations into the variable speed drive.

### BRIEF DESCRIPTION OF DRAWINGS

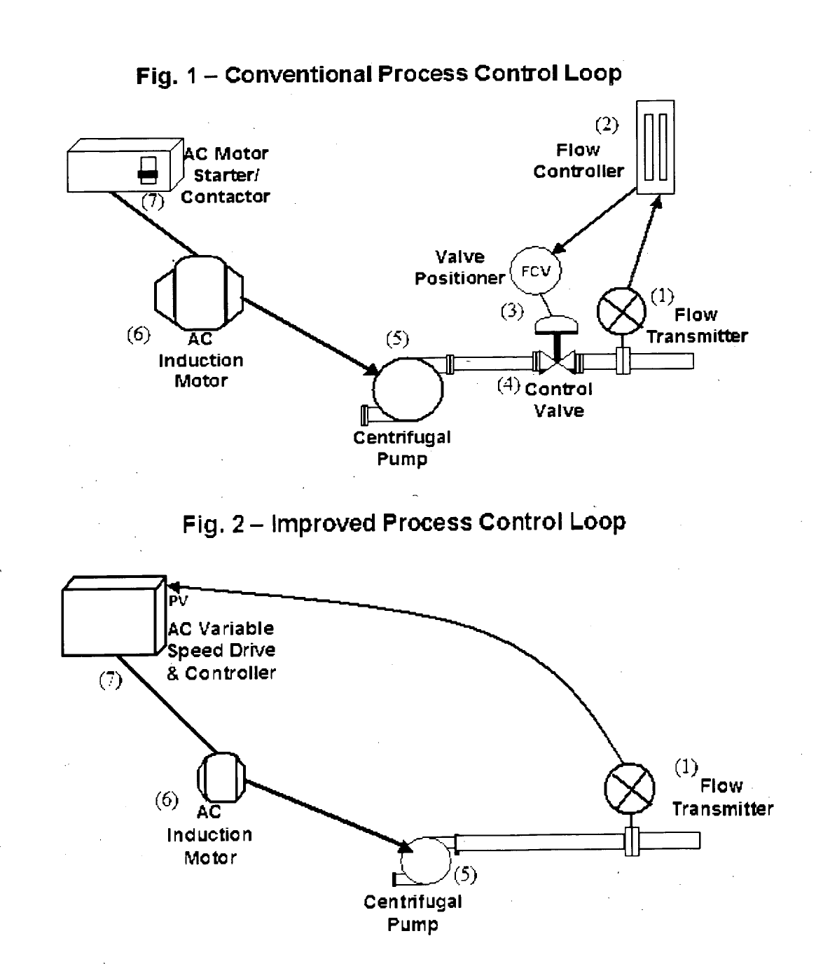

### Brief Description of FIG. 1

FIG. 1 illustrates a conventional process control loop using a pneumatic (compressed air-operated) flow control valve (4) equipped with a valve positioner (3). The value of the flow is sensed by the Flow Transmitter (1) and sent to the controller (2). The controller compares the value of the flow signal with the desired setpoint and computes a new value for the control valve position, which it sends to the valve positioner (3). The valve positioner adjusts the air pressure being applied to the control valve's pneumatic force motor, thereby repositioning the control valve (4) and changing the rate of flow by increasing or decreasing the pressure drop at the control valve. The centrifugal pump (5) and its AC electric motor (6) operate at a constant speed. The AC electric motor must use a three phase starter or contactor (7).

### Brief Description of FIG. 2

FIG. 2 illustrates the effect of applying this invention forming an improved process control loop. The separate controller, control valve, and its positioner are no longer required. The pump (5) and its AC electric motor (6) are smaller. An AC variable speed drive unit (7) has replaced the motor starter/contactor. Using available fieldbus technology, the flow transmitter (1) now sends its flow signal (PV) directly to the variable speed drive (7) that contains the flow control logic. The desired flow setpoint (SP) has been received from the controller across the network connection. The flow control logic compares the value of the flow with the desired setpoint and directly adjusts the speed of the electric motor by electronically changing the output frequency of the AC variable speed drive (7). The centrifugal pump (5) that is directly driven by the electric motor (6) will now operate at an increased or decreased speed thereby changing the flow rate directly.

What is claimed is:

1. A method for improving responsiveness, stability, and accuracy of a process control loop by using an apparatus consisting of an electronic variable speed drive as the final control element instead of using a more conventional apparatus consisting of a proportioning control valve with a pneumatic, hydraulic, or electrical actuator and a feedback positioning device.

2. Apparatus of claim 1 with the loop controller function implemented within the variable speed drive electronics.

3. Apparatus of claim 1 with a separate loop controller sending its output to the speed setpoint of the variable speed drive.

4. Apparatus of claim 1 with a control loop located at another device on the same data communications network or fieldbus and sending its output to the speed setpoint of the variable speed drive.

5. A method of eliminating fugitive emissions of a control loop by using the apparatus of claim 1.

6. A method of reducing the maintenance requirements for the final control element of a control loop by using the apparatus of claim 1.

7. A method of eliminating fugitive emissions of a control loop by using the apparatus of claim 2.

8. A method of reducing the maintenance requirements for the final control element of a control loop by using the apparatus of claim 2.

9. A method of eliminating fugitive emissions of a control loop by using the apparatus of claim 3.

10. A method of reducing the maintenance requirements for the final control element of a control loop by using the apparatus of claim 3.

11. A method of eliminating fugitive emissions of a control loop by using the apparatus of claim 4.

12. A method of reducing the maintenance requirements for the final control element of a control loop by using the apparatus of claim 4.

13. A method improving responsiveness, stability, and accuracy of an airflow control loop by using an apparatus consisting of an electronic variable speed drive as the final control element of the airflow control loop instead of a more conventional apparatus consisting of a variable positioning damper with a pneumatic, hydraulic, or electrical actuator, and a feedback positioning device.

14. Apparatus of claim 13 with the controller function implemented within the variable speed drive electronics.

15. Apparatus of claim 13 with a separate loop controller sending its output to the speed setpoint of the variable speed drive.

16. Apparatus of claim 13 with a loop controller located in another device on the same data communications network or fieldbus and sending its output to the speed setpoint of the variable speed drive.

17. A method for reduction in noise of an air handling system airflow control loop by using the apparatus of claim 13.

18. A method for reducing the maintenance requirements for the final control element of an airflow control loop by using the apparatus of claim 13.

19. A method for reduction in noise of an air handling system airflow control loop by using the apparatus of claim 14.

20. A method for reducing the maintenance requirements for the final control element of an airflow control loop by using the apparatus of claim 14.

21. A method for reduction in noise of an air handling system airflow control loop by using the apparatus of claim 15.

22. A method for reducing the maintenance requirements for the final control element of an airflow control loop by using the apparatus of claim 15.

23. A method for reduction in noise of an air handling system airflow control loop by using the apparatus of claim 16.

24. A method for reducing the maintenance requirements for the final control element of an airflow control loop by using the apparatus of claim 16.
